(19) United States
(12) Patent Application Publication
(10) Pub. No.: US 2022/0066581 A1
(43) Pub. Date: Mar. 3, 2022

(54) PANELS FOR TOUCH SCREENS

(71) Applicant: HEWLETT-PACKARD DEVELOPMENT COMPANY, L.P., SPRING, TX (US)

(72) Inventors: CHUNG HUA KU, TAIPEI CITY (TW); KUO-CHIH HUANG, TAIPEI CITY (TW); CHI HAO CHANG, TAIPEI CITY (TW); KUAN-TING WU, TAIPEI CITY (TW)

(21) Appl. No.: 17/418,404

(22) PCT Filed: Jan. 9, 2019
(86) PCT No.: PCT/US2019/012809

§ 371 Date: Jun. 25, 2021

(51) Int. Cl. G06F 3/041; B32B 15/00; B44C 1/00

(52) U.S. Cl. CPC G06F 3/041; G06F 2203/04103; B44C 1/00; B32B 15/00

(57) ABSTRACT

A panel for a touch screen of an electronic device is described. The panel comprises a substrate having a central area for operating the touch screen and a border area at an edge of the central area. The border area comprises a decorative image on the substrate and an outer surface coating overlying the decorative image. The decorative image comprises a non-conductive metallic coating. The outer surface coating comprises a non-conductive, printed layer. A method for manufacturing the panel and an electronic device comprising a touch screen having the panel are also described.

### BACKGROUND

Many portable electronic devices include a touch screen, which may provide both a display screen and an input apparatus that allows the user to operate the device. The touch screen has a panel with touch elements that respond to the touch of a user. For portability, it is desirable to provide a light-weight and thin touch screen. This means that electrical wiring or circuitry for the touch screen is normally routed through the panel to an edge of the electronic device. This allows the electrical circuitry to be connected to an electrical component of the electronic device, such as, for example, a port, an antenna or a power supply connection.

### BRIEF DESCRIPTION OF THE DRAWINGS

FIG. 1 shows an example of a touch screen of an electronic device.

FIGS. 2 and 3 schematically show a cross-section through examples of panels for a touch screen of an electronic device.

FIGS. 4 and 5 are flows charts showing examples of a method for manufacturing a panel for a touch screen of an electronic device.

The figures depict several examples of the present disclosure. It should be understood that the present disclosure is not limited to the examples depicted in the figures.

### DETAILED DESCRIPTION

As used in the present disclosure, the term “about” is used to provide flexibility to an endpoint of a numerical range. The degree of flexibility of this term can be dictated by the particular variable and is determined based on the associated description herein.

Amounts and other numerical data may be expressed or presented herein in a range format. It is to be understood that such a range format is used merely for convenience and brevity and thus should be interpreted flexibly to include not just the numerical values explicitly recited as the limits of the range, but also to include individual numerical values or sub-ranges encompassed within that range as if each numerical value and sub-range is explicitly recited.

As used in the present disclosure, the term “disposed” when used to refer to the location or position of a coating or a layer includes the term “deposited” or “coated”.

As used in the present disclosure, the term “non-conductive” refers to a feature that is not electrically conductive.

As used in the present disclosure, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

It is noted that, as used in this specification and the appended claims, the singular forms “a”, “an” and “the” include plural referents unless the context clearly dictates otherwise.

The present disclosure refers herein to a panel for a touch screen of an electronic device, to a method for manufacturing the panel and to an electronic device.

The panel comprises a substrate having a central area for operating the touch screen and a border area at an edge of the central area. The border area comprises a decorative image on the substrate and an outer surface coating overlying the decorative image. The decorative image comprises a non-conductive metallic coating. The outer surface coating comprises a non-conductive, printed layer.

The electronic device comprises a touch screen. The touch screen comprises the panel.

The method is for manufacturing a panel for a touch screen of an electronic device. A non-conductive metallic coating is applied to a border area of a substrate to form a decorative image thereon. The border area is at an edge of a central area of the substrate for operating the touch screen. A layer of a non-conductive coating is applied over the decorative image to form an outer surface coating.

It is to be understood that this disclosure is not limited to the housings, electronic devices or methods disclosed herein. It is also to be understood that the terminology used in this disclosure is used for describing particular examples.

### Panel

The panel is for a touch screen of an electronic device. The panel comprises a substrate. The substrate may comprise glass or a glass ceramic.

The panel has a central area for operating the touch screen. The central area may comprise a touch element for responding to the touch of a user.

The central panel may be transparent.

The panel also has a border area at an edge of the central area. The border area may provide a frame or a bezel around the central area. Thus, the border area may surround the central area.

The border area may have a width of ≤30 mm. The width is the distance between the border area at an edge of the panel and the central area for the touch screen.

The border area may have a width of about 2 mm to 30 mm, such as 5 mm to 20 mm.

The border area surrounding the touch screen contains space that could potentially be used to include other features. A difficulty with including other features, particularly features having metallic components, is that they can interfere with the touch trace routing of the panel. Touch trace routing occurs where there is electromagnetic interference between a touch element, such as a touch sensor electrode, and a metallic component in the border area of the panel. Electrical components for the touch screen may be routed under or through the panel. A metallic component in the border area may interfere with the electrical signals routed under or through the panel, which can affect the operability of the touch screen.

To minimise the weight of the housing and to maximise the viewable area of the display screen, panels having smaller border areas are being manufactured, which can exacerbate the problems associated with touch trace routing.

In the present disclosure, the border area comprises a decorative image on the substrate. The decorative image may be a logo. The decorative image or logo is not a coil.

The coatings described below are, at least, applied in the part of the border area having the decorative image.

The decorative image comprises a non-conductive metallic coating. The non-conductive metallic coating in the present disclosure does not interfere with touch trace routing or any other electrical signals routed under or through the panel. The non-conductive metallic coating has an attractive metallic appearance and allows a decorative image to be obtained, which has a sufficient metallic luster that can be maintained.

The non-conductive metallic coating may be a non-conductive vapor metallization (NCVM) coating or a non-conductive metallic paint (NCMP) coating.

In one example, the non-conductive metallic coating is a NCVM coating. The NCVM coating may comprise a metal or a metal alloy. The metal may be selected from aluminum, copper, platinum, titanium, gold, nickel, silver, tin and indium. The metal alloy may be selected from steel and an alloy of at least one of aluminum, copper, platinum, titanium, gold, nickel, silver, tin or indium. In one example, the NCVM coating comprises aluminum or an aluminum alloy.

When the non-conductive metallic coating is a NCVM coating, then the NCVM coating has a thickness of about ≤1 μm. NCVM coatings having a thickness of 1 μm or less are formed as a non-continuous metallic particle layer, which can form a non-conductive surface by NCVM deposition.

The NCVM coating may have a thickness of about 0.010 μm to about 0.500 μm, such as from about 0.015 μm to about 0.250 μm. In one example, the NCVM coating has a thickness of about 0.020 μm to about 0.100 μm.

In another example, the non-conductive metallic coating is a non-conductive metallic paint (NCMP) coating. The non-conductive metallic paint coating may also act as a primer coating for the substrate. This can reduce the overall number of coatings that are applied to the substrate.

The NCMP coating may comprise a metallic powder encapsulated within a polymer. The encapsulation of the metallic powder within a polymer coating can render the metallic powder non-conductive.

The metallic powder may comprise aluminium, zinc, chromium or nickel. In one example, the NCMP coating comprises an aluminum powder encapsulated within a polymer.

The polymer may be selected from a polyacrylic resin, a polycarbonate, a cyclic olefin copolymer (COC), and a polyester. The polymer may, for example, be a polyacrylic resin.

In one example, the NCMP coating comprises an aluminum powder encapsulated within a polyacrylic resin.

When the non-conductive metallic coating is a NCMP coating, then the NCMP coating has a thickness of about ≤15 μm. The NCMP coating may have a thickness of about 0.5 μm to about 25 μm, such as from about 1.0 μm to about 20 μm. In one example, the NCMP coating has a thickness of about 5 μm to about 15 μm.

The non-conductive metallic coating of the decorative image may be disposed directly on to a surface of the substrate or on to a surface of the substrate comprising a black matrix. This means that there is no intervening layer or coating between the non-conductive metallic coating and the surface of the substrate or a surface of the substrate with a black matrix.

When the non-conductive metallic coating is disposed directly on to a surface of the substrate or a surface of the substrate with a black matrix, then the non-conductive metallic coating may be a NCMP coating.

Alternatively, the non-conductive metallic coating of the decorative image may be disposed on a primer coating. The primer coating may be disposed on to a surface of the substrate or on to a surface of the substrate comprising a black matrix. The non-conductive metallic coating may be disposed directly on to a primer coating, and the primer coating is disposed directly on to a surface of the substrate. There may be no intervening layer or coating between the primer coating and the surface of the substrate or the surface of the substrate with the black matrix. There may be no intervening layer or coating between the primer coating and the non-conductive metallic coating.

The primer coating may be transparent.

The primer coating may comprise a polymer, such as polyurethane.

The primer coating may comprise a filler, such as a filler selected from carbon black, titanium dioxide, clay, mica, talc, barium sulfate, calcium carbonate, a synthetic pigment, a metallic powder, aluminum oxide, carbon nanotubes (CNTs), graphene, graphite, and an organic powder. The organic powder may, for example, be an acrylic, a polyamide, a polyester or an epoxide. The primer coating, for example, comprise a polymer and a filler as described above.

The primer coating may have a thickness of about 0.5 μm to about 25 μm, such as from about 1.0 μm to about 20 μm. In one example, the primer coating has a thickness of about 5 μm to about 15 μm.

A heat resistant material, such as a silica aerogel, may be included in the primer coating. In an example, the primer coating layer contains a heat resistant material, a filler as described above and optionally a polyurethane.

The border area also comprises an outer surface coating overlying the decorative image. Thus, the outer surface coating is disposed directly on to the non-conductive metallic coating. The outer surface coating protects the non-conductive metallic coating and may include components to color the border area.

The outer surface coating is non-conductive and, for example, it is not an antenna.

The outer surface coating has a different composition to the composition of the non-conductive metallic coating.

The outer surface coating is the topmost coating of the border area. No other coating is disposed on the outer surface coating.

The outer surface coating may comprise a black top coating or a white base coating or a black top coating and a white base coating.

The outer surface coating may comprise a single layer or two layers.

In one example, the outer surface coating comprises a single layer. The outer surface coating may be a black top coating or a white base coating.

In another example, the outer surface coating comprises two layers. The outer surface coating may comprise a black top coating and a white base coating. The black top coating may be disposed on the white base coating. The black top coating may be disposed directly on to the white base coating. This means that there is no intervening layer between the black top coating and the white base coating.

The topmost layer can be the black top coating.

Generally, the black top coating has a thickness of about 5 μm to about 25 μm, such as about 15 μm to about 20 μm.

The white base coating may have a thickness of about 5 μm to about 25 μm, such as about 15 μm to about 20 μm.

The black top coating may comprise carbon black or a black dye.

The black top coating may comprise a polymer selected from a polyurethane, a polycarbonate, a urethane acrylate, a polyacrylate, a polystyrene, a polyetheretherketone, a polyester, a fluoropolymer and a mixture thereof. Examples of fluoropolymers include fluoroacrylates, fluorosiliconeacrylates, fluorourethanes, perfluoropolyethers, perfluoropolyoxetanes, fluorotelomers, polytetrafluoroethylene (PTFE), polyvinylidenefluouride (PVDF), fluorosiloxane, fluoroUV polymers and hydrophobic polymers.

The black top coating may be transparent.

The black top coating may have hydrophobic, anti-bacterial, anti-smudge, and anti-fingerprint properties. By using an anti-smudging top coating layer, the surface of the panel may be smudge free.

The white base coating may comprise a titanium dioxide pigment, a calcium carbonate pigment or a combination thereof.

The white base coating may comprise a polyurethane-containing pigment.

The white base coating layer may further comprise at least one of clay, mica, talc, barium sulfate, aluminum oxide, an organic powder or plastic beads. The organic powder may, for example, be an acrylic, a polyurethane, a polyamide, a polyester or an epoxide.

The white base coating may be transparent.

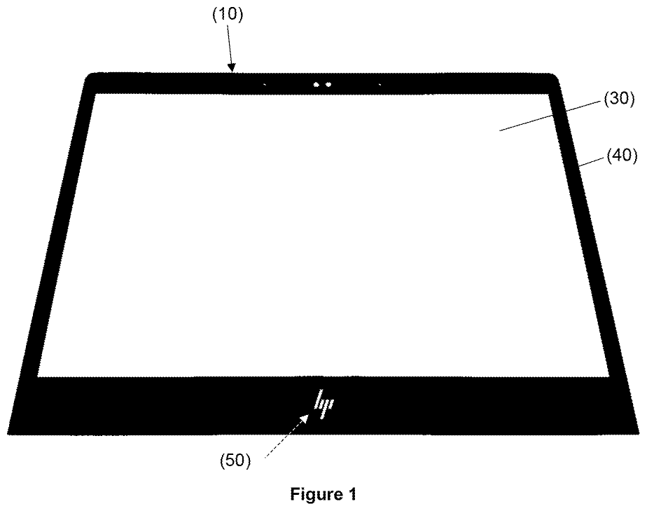

An example of a touch screen for an electronic device is shown in FIG. 1. The touch screen has a panel 10 with a central area 30 and a border area 40. The border area has a decorative image 50, which is a logo.

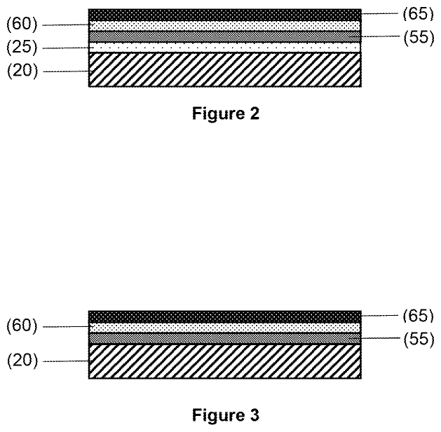

FIG. 2 shows an example of a panel of the present disclosure. A cross-section through a border area of the pan& is shown. The pan& has a substrate 20. A transparent primer coating 25 disposed on the substrate. An NCVM coating 55 is disposed on the transparent primer coating 25. A white base coating 60 is disposed on the NCVM coating 55. A black top coating 65 is disposed on the white base coating 60.

Another example of a panel of the present disclosure is shown in FIG. 3. An NCMP coating 55 is disposed on the substrate 20. A white base coating 60 is disposed on the NCMP coating 55. A black top coating 65 is disposed on the white base coating 60.

### Method of Manufacture

The present disclosure also relates to a method for manufacturing a panel for a touch screen of an electronic device.

A non-conductive metallic coating is applied to a border area of the substrate. The non-conductive metallic coating is applied to a part of the border area that will contain the decorative image.

When the non-conductive metallic coating is a NCVM coating, then the NCVM coating may be applied by generating a metal vapor under a reduced pressure. The term “reduced pressure” in this context refers to a pressure that is below atmospheric pressure, such as about ≤10⁻³ mbar. The NCVM coating may be applied in a vacuum chamber.

The metal vapor is then allowed to condense on a surface to form a NCVM coating. The surface may be a surface of the substrate, a surface of the substrate comprising a black matrix or a coated surface of the substrate, such as when there is a primer coating on the substrate.

The metal vapor may be allowed to condense on the surface to achieve a thickness of about ≤1 μm, such as 0.010 μm to about 0.500 μm.

When the non-conductive metallic coating is a MCMP coating, then a liquid comprising the metallic powder encapsulated within a polymer may be applied to the substrate to form a NCMP coating. The liquid is applied on to a surface, which may be a surface of the substrate, a surface of the substrate comprising a black matrix or a coated surface of the substrate, such as when there is a primer coating on the substrate. The liquid may be printed, sprayed, rollered or brushed onto the surface.

In one example, the liquid is applied on to the surface by inject printing or screen printing.

The liquid may be a solution or a suspension of the metallic powder encapsulated within a polymer, such as an aqueous solution or suspension. The liquid may, for example, comprise 0.5 to 20 wt % of the metallic powder encapsulated within a polymer. In one example, the liquid comprises 1 to 12 wt % of the metallic powder encapsulated within a polymer.

An amount of liquid may be applied to the surface to achieve a thickness of about ≤15 μm, such as about 0.5 μm to about 25 μm.

After the liquid has been applied to the surface, the surface may be dried to form the NCMP coating.

A black matrix may be applied to a border area of the substrate. The black matrix may be applied on to a surface of the substrate by inject printing or by screen printing.

A primer coating may be applied to a border area of the substrate. The primer coating may be applied to a surface of the substrate or to a surface of the substrate comprising a black matrix.

The primer coating may be applied by inject printing or by screen printing on to a surface of the substrate or on to a surface of the substrate comprising the black matrix. The primer coating may be applied before the non-conductive metallic coating is applied.

An outer surface coating is applied to the substrate after the non-conductive metallic coating has been applied.

The outer surface coating comprises a non-conductive coating. The non-conductive coating may be printed as a layer over the decorative image to form the outer surface coating. Thus, the non-conductive coating is applied on to a surface of the non-conductive metallic coating.

In general, the outer surface coating may be applied by inject printing or by screen printing.

Once the outer surface coating has been applied, no other layers or coatings may be applied to the substrate. The outer surface coating is the topmost coating of the panel in the region of the decorative image.

The outer surface coating may comprise a black top coating or a white base coating or a black top coating and a white base coating.

When the outer surface coating comprises a single layer, then either the black top coating or the white base coating is printed on to the substrate, such as by printing on to the non-conductive metallic coating. The black top coating or the white base coating may be applied by inject printing or screen printing.

When the outer surface coating comprises two layers, then a black top coating and a white base coating is sequentially printed on to the substrate. The black top coating may be applied by inject printing or screen printing. The white base coating may be applied by inject printing or screen printing.

In one example, the white base coating is printed on to the non-conductive metallic coating. The black top coating is then printed on to the white base coating.

Each coating may be applied to achieve a desired thickness. The thickness of each layer can be measured after it has been applied using, for example, a micrometer screw gauge.

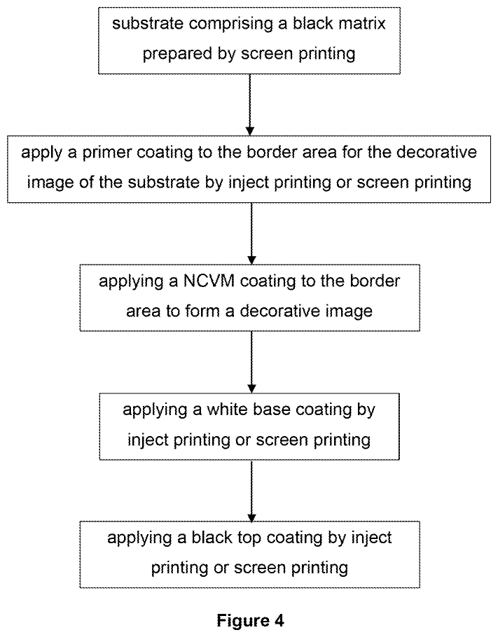

An example of a method for manufacturing a panel for a touch screen of the present disclosure is shown in the flow chart of FIG. 4. A substrate is coated with a black matrix by screen printing. A primer coating is then applied to the border area of the panel in, at least, the location of the decorative image by inject printing or screen printing. After application of the primer coating, a NCVM coating is applied on to the primer coating to form a decorative image. A white base coating and then a black top coating is then sequentially applied on to the NCVM coating, where each coating is applied by either inject printing or screen printing.

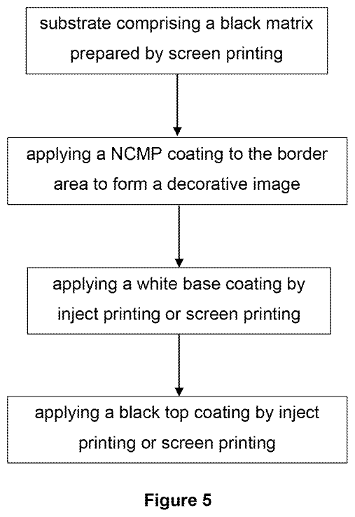

FIG. 5 is a flow chart showing another example of a method for manufacturing a panel for a touch screen of the present disclosure. A substrate is coated with a black matrix by screen printing. A NCMP coating is applied on to the substrate to form a decorative image. A white base coating and then a black top coating is then sequentially applied on to the NCMP coating, where each coating is applied by either inject printing or screen printing.

### Electronic Device

The electronic device comprises a touch screen having a panel.

The panel may overlay a display screen. The display screen may be an LCD screen or an LED screen. The term “LED screen” as used herein includes an organic LED (OLED) screen.

The electronic device of the present disclosure may be a computer, a cell phone, a portable networking device, a portable gaming device or a portable GPS. The computer may be portable. When the computer is portable, it may be a laptop or a tablet.

The electronic device may have electrical wiring or circuitry that passes under or through the border area of the panel.

The electronic device may have a power supply port or a cable port, such as a USB port. The power supply port or the cable port may be located in an edge of the electronic device, such as an edge of the touch screen.

### EXAMPLES

The present disclosure will now be illustrated by the following non-limiting example.

### Example 1

A glass panel for a touch screen was coated in a border area using a primer coating by screen printing. Non-conductive vapor metallization was then used to apply a NCVM coating onto the primer coating in the border area. The NCVM coating comprised non-conductive deposited aluminium particles and was applied in the shape of a logo. A white base coating was printed on top of the NCVM coating, followed by a black top coating.

A touch screen was assembled from the glass panel. The touch screen was tested for interference due to touch screen routing. No interference was observed and the resulting touch screen had an attractive decorative image that was found to retain its metallic luster.

### Example 2

A non-conductive metallic paint (NCMP) coating comprising aluminum powder encapsulated within a polymeric resin was screen printed onto the border area of panel for a touch screen. The NCMP coating was printed onto panel in the shape of a logo. A white base coating was printed on top of the NCVM coating, followed by a black top coating.

A touch screen was assembled from the glass panel. The touch screen was tested for interference due to touch screen routing. No interference was observed and the resulting touch screen had an attractive decorative image that was found to retain its metallic luster.

1. A panel for a touch screen of an electronic device, wherein the panel comprises a substrate having a central area for operating the touch screen and a border area at an edge of the central area, wherein the border area comprises:
a decorative image on the substrate, wherein the decorative image comprises a non-conductive metallic coating, and
an outer surface coating overlying the decorative image, wherein the outer surface coating comprises a non-conductive, printed layer.

2. The panel of claim 1, wherein the non-conductive metallic coating is a non-conductive vapor metallization (NCVM) coating or a non-conductive metallic paint (NCMP) coating.

3. The panel of claim 2, wherein the non-conductive metallic coating is a non-conductive vapor metallization (NCVM) coating, which comprises a metal or a metal alloy.

4. The panel of claim 3, wherein the metal is selected from aluminum, copper, platinum, titanium, gold, nickel, silver, tin and indium, and wherein the metal alloy is selected from steel and an alloy of at least one of aluminum, copper, platinum, titanium, gold, nickel, silver, tin or indium.

5. The panel of claim 3, wherein the NCVM coating has a thickness of about ≤1 μm.

6. The panel of claim 2, wherein the non-conductive metallic coating is a NCMP coating, wherein the NCMP coating comprises a metallic powder encapsulated within a polymer.

7. The panel of claim 6, wherein the NCMP coating comprises an aluminum powder encapsulated within a polyacrylic resin.

8. The panel of claim 6, wherein the NCMP coating has a thickness of about ≤15 μm.

9. The panel of claim 1, wherein the outer surface coating may comprise (i) a black top coating, or (ii) a white base coating or (iii) a black top coating and a white base coating.

10. The panel of claim 9, wherein the outer surface coating comprises a black top coating having a thickness of about 10 to about 25 μm.

11. The panel of claim 9, wherein the outer surface coating comprises a white base coating having a thickness of about 10 to about 25 μm.

12. A method for manufacturing a panel for a touch screen of an electronic device, which method comprises:
applying a non-conductive metallic coating to a border area of a substrate to form a decorative image thereon, wherein the border area is at an edge of a central area of the substrate for operating the touch screen; and
applying a layer of a non-conductive coating over the decorative image to form an outer surface coating.

13. The method of claim 12, wherein the non-conductive metallic coating is a NCVM coating, which is applied by generating a metal vapor under a reduced pressure of about ≤10⁻³ mbar.

14. The method of claim 12, wherein the non-conductive metallic coating is a a MCMP coating, wherein a liquid comprising a metallic powder encapsulated within a polymer is applied to the substrate to form a NCMP coating.

15. An electronic device comprising a touch screen having a panel, wherein the panel comprises a substrate having a central area for operating the touch screen and a border area at an edge of the central area, wherein the border area comprises:
a decorative image on the substrate, wherein the decorative image comprises a non-conductive metallic coating, and
an outer surface coating overlying the decorative image, wherein the outer surface coating comprises a non-conductive, printed layer.
